(19) United States
(12) Patent Application Publication
(10) Pub. No.: US 2026/0275745 A1
(43) Pub. Date: Sep. 17, 2026

(54) SWIMMING POOL ROBOT ESCAPE METHOD, SYSTEM, AND MEDIUM

(71) Applicant: Seauto (Guangdong Hengqin) Technology Co., Ltd., Zhuhai City (CN)

(72) Inventors: Zhineng Deng, Zhuhai City (CN); Weibin Xu, Zhuhai City (CN)

(21) Appl. No.: 19/678,836

(22) Filed: May 15, 2026

Related U.S. Application Data
(63) Continuation of application No. PCT/CN2024/079768, filed on Mar. 2, 2024.

(30) Foreign Application Priority Data
Dec. 11, 2023 (CN) 202311689457.3

(51) Int. Cl. E04H 4/16; G05D 1/639; G05D 105/10; G05D 107/00

(52) U.S. Cl. CPC E04H 4/1654; G05D 1/639; G05D 2105/10; G05D 2107/29

(57) ABSTRACT

A swimming pool robot escape method, system, and medium, the method including the following steps: acquiring a current operation status of the swimming pool robot; determining an entrapment type of the swimming pool robot according to a type of an abnormality operation status in response to detecting that the current operation status is the abnormality operation status; executing a corresponding escape strategy according to the entrapment type of the swimming pool robot. The present disclosure may improve an escape capability of the swimming pool robot, prevent the swimming pool robot from being stuck in one place for a long time, thereby improving an adaptability of the swimming pool robot to different environments, and enable the swimming pool robot to normally perform cleaning work in more swimming pools.

### CROSS REFERENCE TO RELATED APPLICATIONS

The present application is a Continuation Application of PCT Application No. PCT/CN2024/079768 filed on Mar. 2, 2024, which claims priority of Chinese Patent Application No. 2023116894573 filed on Dec. 11, 2023, before CNIPA. All the above are hereby incorporated by reference in their entirety as part of the present disclosure.

### TECHNICAL FIELD

The present disclosure relates to the technical field of robots, and specifically relates to a swimming pool robot escape method, system, and medium.

### BACKGROUND

The swimming pool cleaning robot is a household-level consumer robot configured to clean swimming pools, functions of which are similar to those of a floor cleaning robot, the difference from the floor cleaning robot is that the application scenario thereof is underwater, the swimming pool cleaning robot needs to operate in a swimming pool, the cleaning of swimming pools has always been a pain point, manual cleaning is cumbersome and time-consuming, the industry generally starts to use machines to perform swimming pool cleaning operations, many companies are researching path planning related algorithms, causing the machine to clean the swimming pool according to a set route, achieving higher cleaning efficiency.

The cleaning robots currently on the market lack some escape algorithms, sometimes there are some stones or protruding obstacles on the swimming pool bottom, the machine chassis is stuck thereby, causing the robot may not move, if effective detection and identification may not be performed, and special handling is not performed, the robot will stay in one place continuously, making it difficult to carry out normal cleaning operations.

### SUMMARY

A primary objective of the present disclosure is to propose a swimming pool robot escape method, system, and medium, aimed at improving the escape capability of the swimming pool robot and the adaptability of the swimming pool robot to different environments.

To achieve the above objective, the present disclosure provides a swimming pool robot escape method, where the method includes the following steps:
step S10, acquiring a current operation status of the swimming pool robot;
step S20, determining, according to a type of an abnormality operation status, an entrapment type of the swimming pool robot in response to detecting the current operation status being the abnormality operation status;
step S30, performing a corresponding escape strategy according to the entrapment type of the swimming pool robot.

In some implementations, the step S20 of determining, according to the type of the abnormality operation status, the entrapment type of the swimming pool robot in response to detecting the current operation status being the abnormality operation status includes:
step S201, determining the entrapment type of the swimming pool robot as being stuck by an external obstacle if the type of the abnormality operation status is deviating from a set heading.

In some implementations, the swimming pool robot is provided with a water pumping motor, and a pressure between the swimming pool robot and a swimming pool bottom increases in response to turning on the water pumping motor, and the pressure between the swimming pool robot and the swimming pool bottom decreases in response to turning off the water pumping motor;
the step S30 of performing the corresponding escape strategy according to the entrapment type of the swimming pool robot includes:
step S301, turning off the water pumping motor and controlling the swimming pool robot to move forward for a first preset duration to surmount the obstacle.

In some implementations, the first preset duration is 3 to 30 seconds.

In some implementations, the step S20 of determining, according to the type of the abnormality operation status, the entrapment type of the swimming pool robot in response to detecting the current operation status being the abnormality operation status includes:
step S202, determining that the swimming pool robot encounters an obstacle that is unable to be moved forward in response to the type of the abnormality operation status being a distance between the swimming pool robot and a swimming pool wall being unchanged or having an insignificant change during the swimming pool robot moving forward.

In some implementations, the step S30 of performing the corresponding escape strategy according to the entrapment type of the swimming pool robot includes:
step S302, controlling the swimming pool robot to move backward for a second preset duration, and then controlling the swimming pool robot to steer for motion.

In some implementations, the second preset duration is 2 to 20 seconds.

In some implementations, the swimming pool robot is provided with an inertial measurement unit, IMU, sensor, an acceleration sensor, and an ultrasonic sensor, the IMU sensor and the acceleration sensor are configured to acquire a motion status and a posture angle of the swimming pool robot, and a heading angle of the swimming pool robot is adjusted according to the posture angle; the ultrasonic sensor is configured to detect a distance between the swimming pool robot and the swimming pool wall.

To achieve the above objective, the present disclosure further proposes a swimming pool robot escape system, the system including a memory, a processor, and a swimming pool robot escape program stored on the processor, and the swimming pool robot escape program, when executed by the processor, performs the steps of the method as described above.

To achieve the above objective, the present disclosure further proposes a non-transitory computer-readable storage medium, where the non-transitory computer-readable storage medium is stored with a swimming pool robot escape program, and the swimming pool robot escape program, when executed by a processor, performs the steps of the method as described above.

The beneficial effects of the swimming pool robot escape method, system, and medium of the present disclosure are:

The swimming pool robot escape method of the present disclosure, through the above technical solution, acquiring a current operation status of the swimming pool robot; in response to detecting the current operation status being the abnormality operation status, determining an entrapment type of the swimming pool robot according to a type of the abnormality operation status; performing a corresponding escape strategy according to the entrapment type of the swimming pool robot, leading to an enhanced escape capability of the swimming pool robot, preventing the swimming pool robot from being stuck at a certain location for a long time without moving, thereby enhancing adaptability of the swimming pool robot to different environments, allowing it to perform cleaning work normally in more swimming pools.

### BRIEF DESCRIPTION OF THE DRAWINGS

To more clearly illustrate the technical solutions in the embodiments of the present disclosure or the prior art, the following briefly introduces the accompanying drawings required for describing the embodiments or the prior art. Apparently, the accompanying drawings in the following description show only some embodiments of the present disclosure, and a person of ordinary skill in the art may still derive other drawings from the accompanying drawings provided herein without creative efforts.

FIG. 1 is a schematic flowchart of a first embodiment of a swimming pool robot escape method of the present disclosure;

FIG. 2 is a schematic flowchart of a second embodiment of the swimming pool robot escape method of the present disclosure;

FIG. 3 is a schematic diagram of a swimming pool robot moving forward with a raised front;

FIG. 4 is a schematic flowchart of a third embodiment of the swimming pool robot escape method of the present disclosure.

The realization of objectives, functional features, and advantages of the present disclosure will be further described with reference to the embodiments and accompanying drawings.

### DETAILED DESCRIPTION

The technical solutions in the embodiments of the present disclosure will be clearly and completely described below with reference to the accompanying drawings in the embodiments of the present disclosure. It is apparent that the described embodiments are merely a part of the embodiments of the present disclosure, rather than all the embodiments. All other embodiments obtained by those of ordinary skill in the art based on the embodiments of the present disclosure without creative efforts shall fall within the protection scope of the present disclosure.

The present disclosure provides a swimming pool robot escape method. The technical solution adopted by the present disclosure primarily involves using posture data and distance data fed back by an inertial measurement unit, IMU, sensor, an acceleration sensor, and an ultrasonic sensor of the swimming pool robot to determine whether the swimming pool robot is stuck. Escape is performed according to a corresponding escape strategy to resume normal cleaning work in response to the swimming pool robot being stuck and being unable to move, preventing the swimming pool robot from remaining stuck in one place for a long time, thereby improving the adaptability of the swimming pool robot to different environments, and enabling it to perform cleaning work normally in more swimming pools.

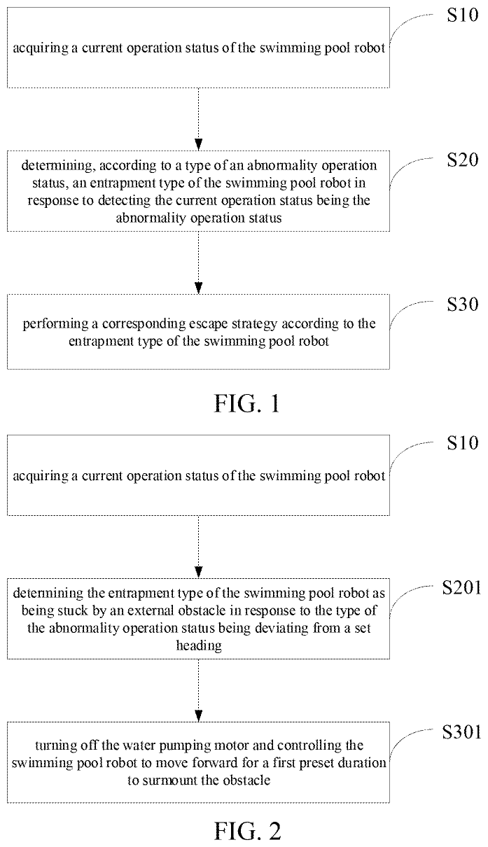

Referring to FIG. 1, FIG. 1 is a schematic flowchart diagram of a first embodiment of the swimming pool robot escape method of the present disclosure.

In the present embodiment, the swimming pool robot escape method includes the following steps:

Step S10: acquiring a current operation status of the swimming pool robot.

In the present embodiment, the swimming pool robot is provided with the inertial measurement unit, IMU, sensor, the acceleration sensor, and the ultrasonic sensor. The current operation status of the swimming pool robot is acquired through the IMU sensor, the acceleration sensor, and the ultrasonic sensor.

For example, a motion status and a posture angle of the swimming pool robot are calculated through the IMU sensor and the acceleration sensor. The swimming pool robot is configured to move forward according to a set heading angle. The heading angle of the swimming pool robot is adjusted in real-time according to the posture angle of the swimming pool robot calculated through the IMU sensor and the acceleration sensor, to ensure that the swimming pool robot does not deviate from the set direction.

A distance between the swimming pool robot and a swimming pool wall is detected through the ultrasonic sensor.

Step S20: determining an entrapment type of the swimming pool robot according to a type of the abnormality operation status in response to detecting that the current operation status is an abnormality operation status.

The type of the abnormality operation status of the swimming pool robot may be, for example, deviating from the set heading, a distance between the swimming pool robot and the swimming pool wall being unchanged or changing insignificantly while the swimming pool robot is moving forward, or not conforming to a normal forward speed.

In some implementations, the entrapment type of the swimming pool robot is determined as being stuck by an external obstacle in response to the type of the abnormality operation status of the swimming pool robot being deviating from the set heading, leading to an inability to normally adjust the heading.

In some implementations, the entrapment type of the swimming pool robot is determined as encountering an obstacle that may not be passed in response to the type of the abnormality operation status of the swimming pool robot being the distance between the swimming pool robot and the swimming pool wall being unchanged or changing insignificantly while the swimming pool robot is moving forward, or not conforming to the normal forward speed.

Step S30: performing a corresponding escape strategy according to the entrapment type of the swimming pool robot.

After determining the entrapment type of the swimming pool robot according to the type of the abnormality operation status, the corresponding escape strategy is performed according to the corresponding entrapment type, controlling the swimming pool robot to surmount the obstacle or steer to avoid the obstacle, and switching to another location to perform cleaning.

The present embodiment, through the aforementioned technical solution, acquires the current operation status of the swimming pool robot; determines the entrapment type of the swimming pool robot according to the type of the abnormality operation status in response to detecting that the current operation status is the abnormality operation status; and performs the corresponding escape strategy according to the entrapment type of the swimming pool robot, which may improve the escape capability of the swimming pool robot, prevent the swimming pool robot from remaining stuck in one place for a long time, thereby improving the adaptability of the swimming pool robot to different environments, and enabling it to perform cleaning work normally in more swimming pools.

Further, referring to FIG. 2, FIG. 2 is a schematic flowchart diagram of a second embodiment of the swimming pool robot escape method of the present disclosure.

A difference between the present embodiment and the first embodiment shown in FIG. 1 is that, in the present embodiment, step S20, the step of determining the entrapment type of the swimming pool robot according to the type of the abnormality operation status in response to detecting that the current operation status is the abnormality operation status includes:

Step S201: determining the entrapment type of the swimming pool robot as being stuck by an external obstacle in response to the type of the abnormality operation status being deviating from the set heading.

In the present embodiment, the swimming pool robot is provided with a water pumping motor. A pressure between the swimming pool robot and a swimming pool bottom increases in response to turning on the water pumping motor. The pressure between the swimming pool robot and the swimming pool bottom decreases in response to turning off the water pumping motor, and resistance during motion of the swimming pool robot decreases, thereby facilitating an increase in a forward power of the swimming pool robot to surmount the obstacle.

Step S30, the step of performing the corresponding escape strategy according to the entrapment type of the swimming pool robot includes:

Step S301: turning off the water pumping motor; and controlling the swimming pool robot to move forward for a first preset duration to surmount the obstacle.

The first preset duration is set based on an emperical value. In the present embodiment, the first preset duration is in some implementations 3 to 30 seconds.

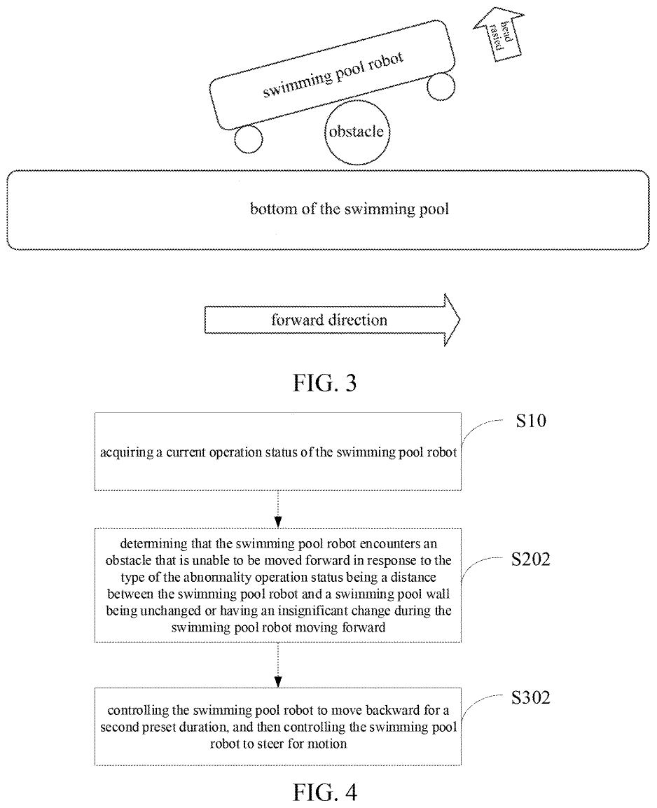

In the present embodiment, the posture angle of the swimming pool robot is calculated through the IMU sensor and the acceleration sensor. Under normal circumstances, the swimming pool robot is configured to move forward according to the set heading angle, and the heading of the swimming pool robot is adjusted in real time through an algorithm to ensure that the swimming pool robot does not deviate from the set direction; however, if it is detected that the swimming pool robot deviates from the set heading for 5 to 60 consecutive seconds, it indicates that the swimming pool robot is stuck by an external obstacle, leading to an inability to normally adjust the heading. The corresponding escape strategy is performed at this time. A specific operation includes turning off the water pumping motor of the robot, and then the swimming pool robot starts to move forward at full speed. Under normal circumstances, the swimming pool robot will then start to move forward with its head raised (as shown in FIG. 3). If there is a stone or other obstacle under the chassis of the swimming pool robot, the robot may directly surmount the obstacle. The escape program is exited and a return is made to executing the normal program after performing the escape strategy for 3 to 30 seconds.

Referring to FIG. 4, FIG. 4 is a schematic flowchart diagram of a third embodiment of the swimming pool robot escape method of the present disclosure.

The present embodiment differs from the first embodiment shown in FIG. 1 in that in the present embodiment, in step S20, the step of, according to the type of the abnormality operation status, determining the entrapment type of the swimming pool robot in response to detecting the current operation status being the abnormality operation status, includes:

Step S202, determining that the swimming pool robot encounters an obstacle that is unable to be moved forward in response to the type of the abnormality operation status being a distance between the swimming pool robot and a swimming pool wall being unchanged or having an insignificant change during the swimming pool robot moving forward.

Step S30, the step of executing a corresponding escape strategy according to the entrapment type of the swimming pool robot includes:

Step S302, controlling the swimming pool robot to move backward for a second preset duration; and then controlling the swimming pool robot to steer for motion; where the second preset duration is set according to an emperical value, and in the present embodiment, the second preset duration is 2 to 20 seconds in some implementations.

In the present embodiment, the distance between the swimming pool robot and the swimming pool wall is detected by an ultrasonic sensor; while the swimming pool robot is moving forward, the distance is determined to change relatively little or be unchanged in response to the change of the distance being inconsistent with a normal forward speed, and it is determined that the swimming pool robot encounters an obstacle that it may not move forward.

Normally, the swimming pool robot moves forward at a uniform speed, and the distance keeps decreasing; if the swimming pool robot is stuck, the distance stays near a certain value; the swimming pool robot is determined to be stuck somewhere and may not move forward in response to the distance changing little or being unchanged, and a corresponding escape procedure begins to be executed; the swimming pool robot starts moving backward at full speed for 2 to 20 seconds, and then the swimming pool robot starts turning, switching to cleaning other areas, thereby avoiding the obstacle on this forward path.

The beneficial effects of the swimming pool robot escape method of the present disclosure are as follows:

The swimming pool robot escape method of the present disclosure may improve the escape capability of the swimming pool robot by acquiring the current operation status of the swimming pool robot; determining the entrapment type of the swimming pool robot according to the type of the abnormality operation status in response to detecting the current operation status being the abnormality operation status; and executing a corresponding escape strategy according to the entrapment type of the swimming pool robot based on the foregoing technical solution, preventing the swimming pool robot from being stuck in one place for a long time, thereby improving the adaptability of the swimming pool robot to different environments, and enabling normal cleaning work to be performed in more swimming pools.

To achieve the above objective, the present disclosure further provides a swimming pool robot escape system, the system including a memory, a processor, and a swimming pool robot escape program stored in the memory; the swimming pool robot escape program is configured to be executed by the processor to perform the steps of the method as described above, which are not repeated here.

To achieve the above objective, the present disclosure further provides a non-transitory computer-readable storage medium, the non-transitory computer-readable storage medium storing a swimming pool robot escape program; the swimming pool robot escape program is configured to be executed by a processor to perform the steps of the method as described in the foregoing embodiments, which are not repeated here.

The foregoing descriptions are merely preferred embodiments of the present disclosure, and are not intended to limit the patent scope of the present disclosure; any equivalent structural transformation made under the concept of the present disclosure using the content of the specification and drawings of the present disclosure, or direct/indirect application in other related technical fields, is included within the patent protection scope of the present disclosure.

What is claimed is:

1. A swimming pool robot escape method, wherein the method comprises the following steps:
step S10, acquiring a current operation status of a swimming pool robot;
step S20, determining, according to a type of an abnormality operation status, an entrapment type of the swimming pool robot in response to detecting the current operation status being the abnormality operation status; and
step S30, performing a corresponding escape strategy according to the entrapment type of the swimming pool robot.

2. The swimming pool robot escape method according to claim 1, wherein the step S20 of determining, according to the type of the abnormality operation status, the entrapment type of the swimming pool robot in response to detecting the current operation status being the abnormality operation status comprises:
step S201, determining the entrapment type of the swimming pool robot as being stuck by an external obstacle if the type of the abnormality operation status is deviating from a set heading.

3. The swimming pool robot escape method according to claim 2, wherein the swimming pool robot is provided with a water pumping motor, and a pressure between the swimming pool robot and a swimming pool bottom increases in response to turning on the water pumping motor, and the pressure between the swimming pool robot and the swimming pool bottom decreases in response to turning off the water pumping motor;
the step S30 of performing the corresponding escape strategy according to the entrapment type of the swimming pool robot comprises:
step S301, turning off the water pumping motor and controlling the swimming pool robot to move forward for a first preset duration to surmount the obstacle.

4. The swimming pool robot escape method according to claim 3, wherein the first preset duration is 3 to 30 seconds.

5. The swimming pool robot escape method according to claim 1, wherein the step S20 of determining, according to the type of the abnormality operation status, the entrapment type of the swimming pool robot in response to detecting the current operation status being the abnormality operation status comprises:
step S202, determining that the swimming pool robot encounters an obstacle that is unable to be moved forward in response to the type of the abnormality operation status being a distance between the swimming pool robot and a swimming pool wall being unchanged or having an insignificant change during the swimming pool robot moving forward.

6. The swimming pool robot escape method according to claim 5, wherein the step S30 of performing the corresponding escape strategy according to the entrapment type of the swimming pool robot comprises:
step S302, controlling the swimming pool robot to move backward for a second preset duration, and then controlling the swimming pool robot to steer for motion.

7. The swimming pool robot escape method according to claim 5, wherein the second preset duration is 2 to 20 seconds.

8. The swimming pool robot escape method according to any one of claims 1 to 7, wherein the swimming pool robot is provided with an inertial measurement unit, IMU, sensor, an acceleration sensor, and an ultrasonic sensor, the IMU sensor and the acceleration sensor are configured to acquire a motion status and a posture angle of the swimming pool robot, and a heading angle of the swimming pool robot is adjusted according to the posture angle; the ultrasonic sensor is configured to detect a distance between the swimming pool robot and the swimming pool wall.

9. A swimming pool robot escape system, the system comprising a memory, a processor, and a swimming pool robot escape program stored on the processor, wherein the swimming pool robot escape program, when executed by the processor, causes the processor to perform the following steps:
step S10, acquiring a current operation status of the swimming pool robot;
step S20, determining, according to a type of an abnormality operation status, an entrapment type of the swimming pool robot in response to detecting the current operation status being the abnormality operation status; and
step S30, performing a corresponding escape strategy according to the entrapment type of the swimming pool robot;
the step S20 of determining, according to the type of the abnormality operation status, the entrapment type of the swimming pool robot in response to detecting the current operation status being the abnormality operation status comprises:
step S201, determining the entrapment type of the swimming pool robot as being stuck by an external obstacle in response to the type of the abnormality operation status being deviating from a set heading.

10. A non-transitory computer-readable storage medium, wherein the non-transitory computer-readable storage medium is stored with a swimming pool robot escape program, and the swimming pool robot escape program, when executed by a processor, performs the following steps:
step S10, acquiring a current operation status of the swimming pool robot;
step S20, determining, according to a type of an abnormality operation status, an entrapment type of the swimming pool robot in response to detecting the current operation status being the abnormality operation status; and
step S30, performing a corresponding escape strategy according to the entrapment type of the swimming pool robot;
the step S20 of determining, according to the type of the abnormality operation status, the entrapment type of the swimming pool robot in response to detecting the current operation status being the abnormality operation status comprises:
step S201, determining the entrapment type of the swimming pool robot as being stuck by an external obstacle in response to the type of the abnormality operation status being deviating from a set heading.
